(19) United States
(12) Patent Application Publication
(10) Pub. No.: US 2017/0267108 A1
(43) Pub. Date: Sep. 21, 2017

(54) POWER SYSTEM FOR A LOCOMOTIVE

(71) Applicant: Electro-Motive Diesel, Inc., LaGrange, IL (US)

(72) Inventor: Madan M. Jalla, Woodbridge, IL (US)

(73) Assignee: Electro-Motive Diesel, Inc., LaGrange, IL (US)

(21) Appl. No.: 15/074,120

(22) Filed: Mar. 18, 2016

(51) Int. Cl. B60L 11/12; F02N 11/08; B60L 7/16; B60L 11/08; B60L 1/00

(52) U.S. Cl. CPC B60L 11/12; B60L 11/08; B60L 1/00; B60L 7/16; F02N 11/08

(57) ABSTRACT

A power system for a locomotive. The power system includes an alternator, a first inverter system, a traction motor, a second inverter system and an auxiliary power unit. The first inverter system is coupled to the alternator and receives high voltage power from the alternator. The traction motor is coupled to the first inverter system receives high voltage power from the first inverter system. The second inverter system is also coupled to the alternator. The second inverter system steps down the high voltage power from the alternator. The auxiliary power unit is coupled to the second inverter system and receives the stepped down voltage power from the second inverter system.

### TECHNICAL FIELD

The present disclosure relates to a power system. In particular, the present disclosure relates to a power system for a locomotive.

### BACKGROUND

A typical locomotive includes a complex electromechanical system comprising a plurality of complex systems and subsystems. Some of these systems and subsystems such as traction motors require high voltage power while auxiliary loads (such as cooling unit, air compressor, etc.) require low voltage power.

Generally the locomotive engine powers a traction alternator (also known as main alternator) and a companion alternator (also known as a secondary alternator). The traction alternator produces high power (2800V max) and transmits this high power to the traction motors. The companion alternator produces power (700V max) and transmits this low power to the auxiliary loads of the locomotive.

Chinese publication No. 202,856,629 discloses a first rectifier unit and a second rectifier unit. The first rectifier unit powers an inverter module and the second rectifier unit powers the auxiliary inverter module. The inverter module powers the main traction motors and the second rectifier unit powers the auxiliary units.

### SUMMARY OF THE INVENTION

In an aspect of the present disclosure, a power system for a locomotive is disclosed. The power system includes an alternator, a first inverter system, a traction motor, a second inverter system and an auxiliary power unit. The first inverter system is coupled to the alternator and receives high voltage power from the alternator. The traction motor is coupled to the first inverter system receives high voltage power from the first inverter system. The second inverter system is also coupled to the alternator. The second inverter system steps down the high voltage power from the alternator. The auxiliary power unit is coupled to the second inverter system and receives the stepped down voltage power from the second inverter system.

In another aspect of the present disclosure, a locomotive is disclosed. The locomotive includes an engine, an alternator driven by the engine, a first inverter system coupled to the alternator and configured to receive high voltage power from the alternator, a traction motor coupled to the first inverter system and configured to receive high voltage power from the first inverter system, a second inverter system coupled to the alternator, the second inverter system configured to step down the high voltage power from the alternator and an auxiliary power unit coupled to the second inverter system, the auxiliary power unit configured to receive the stepped down voltage power from the second inverter system.

In yet another aspect of the present disclosure, a method of powering a locomotive is disclosed. The method includes driving an alternator by an engine, transmitting high voltage power generated by the alternator to a first inverter system, transmitting the high voltage power received by the first inverter system to a traction motor, transmitting high voltage power generated by the alternator to a second inverter system, stepping down the high voltage power received by the second inverter system and transmitting the stepped down power by the second inverter system to an auxiliary power unit.

### BRIEF DESCRIPTION OF THE DRAWINGS

FIG. 1 illustrates a diagrammatic view of a locomotive.

FIG. 2 illustrates a power system for supplying electrical power to a locomotive in accordance with an embodiment.

FIG. 3 illustrates a power system for supplying electrical power to locomotive units in normal mode of operation.

FIG. 4 illustrates a power system supplying electrical power to locomotive during dynamic braking mode of operation wherein the storage apparatus is in its first mode of operation.

FIG. 5 illustrates a power system supplying electrical power to locomotive when the storage apparatus is in its second mode of operation.

FIG. 6 illustrates AEC mode for an alternator.

FIG. 7 depicts a method of powering a locomotive in accordance with an embodiment of the present disclosure.

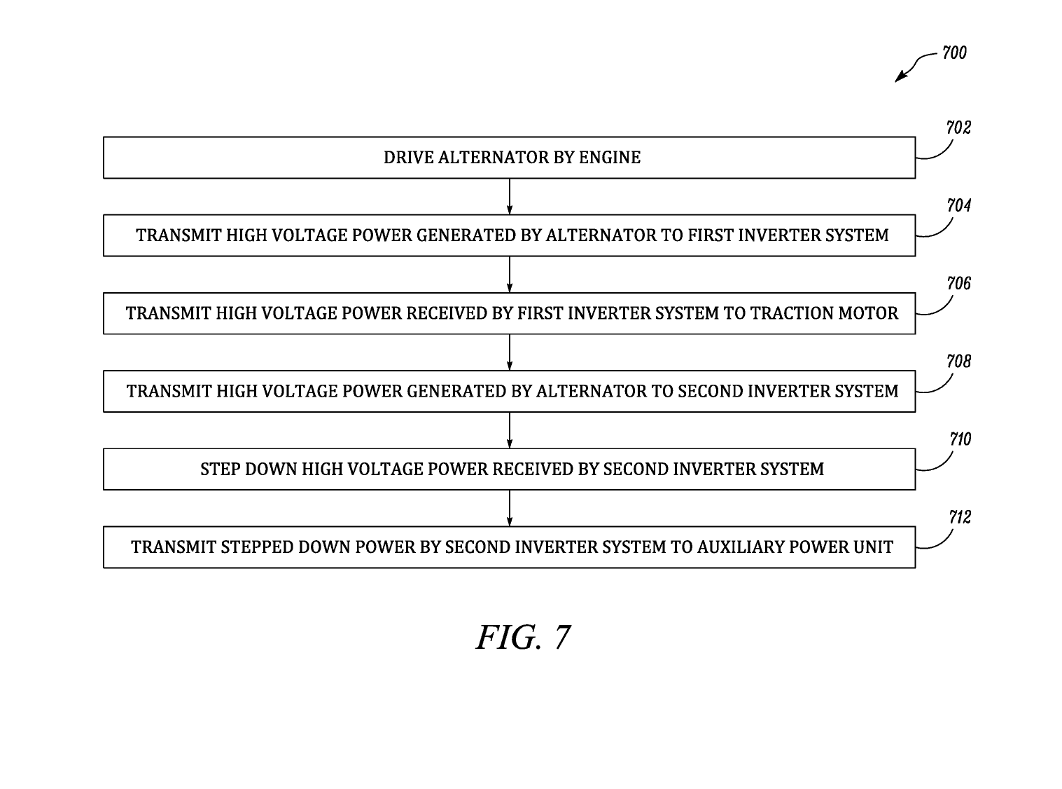

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

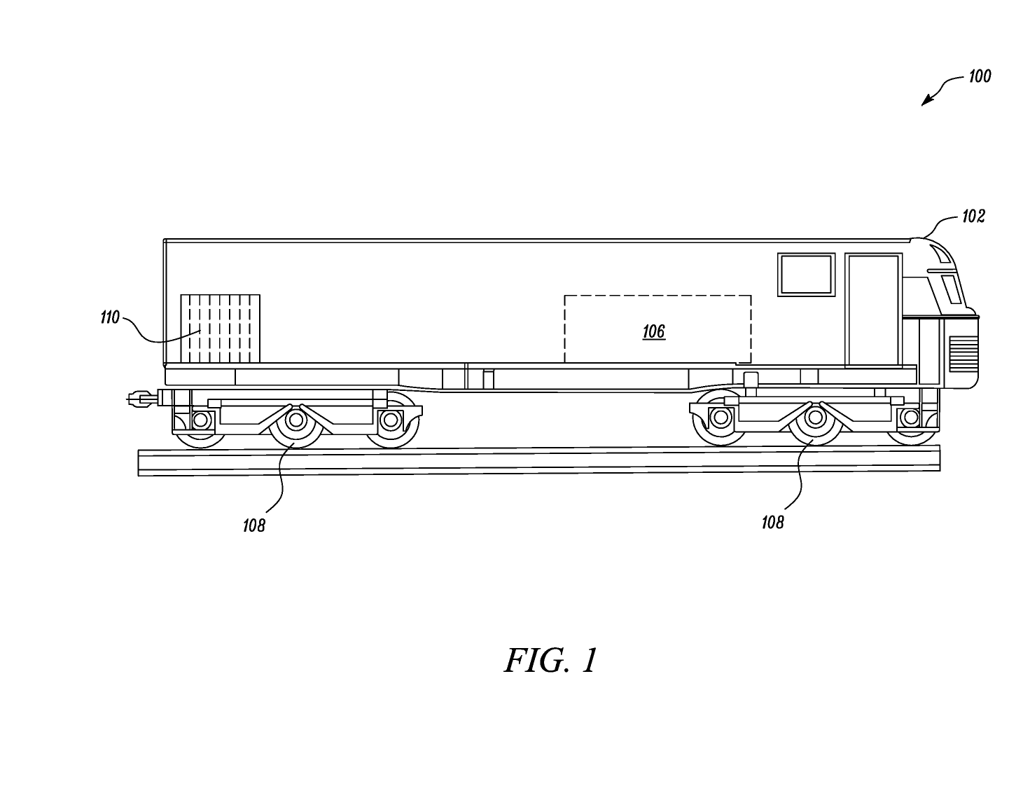

FIG. 1 illustrates an exemplary locomotive 100. The locomotive 100 may include a diesel-electric locomotive or a dual-fueled electric locomotive. The locomotive 100 may include single locomotive, multiple locomotives, a train moved by single locomotive, a train moved by multiple locomotives and any other arrangement of locomotives. As shown in FIG. 1, the locomotive 100 may include a cab 102, an engine compartment (not shown). The engine compartment houses an engine 106. The engine 106 may be a uniflow two-stroke diesel engine system. In an alternate embodiment, the engine 106 may be a four stroke internal combustion engine. In various other embodiments, the engine 106 may be any engine running on solid, liquid or gaseous fuel. Further, the locomotive 100 may also have at least one wheel 108. In an alternate embodiment, the locomotive 100 may include plurality of wheels 108. Those skilled in the art will also appreciate that each locomotive 100 may also, for example facilities used to house electronics, such as electronics lockers (not shown), protective housings for engine compartment and other electrical loads used in conjunction with engine compartment.

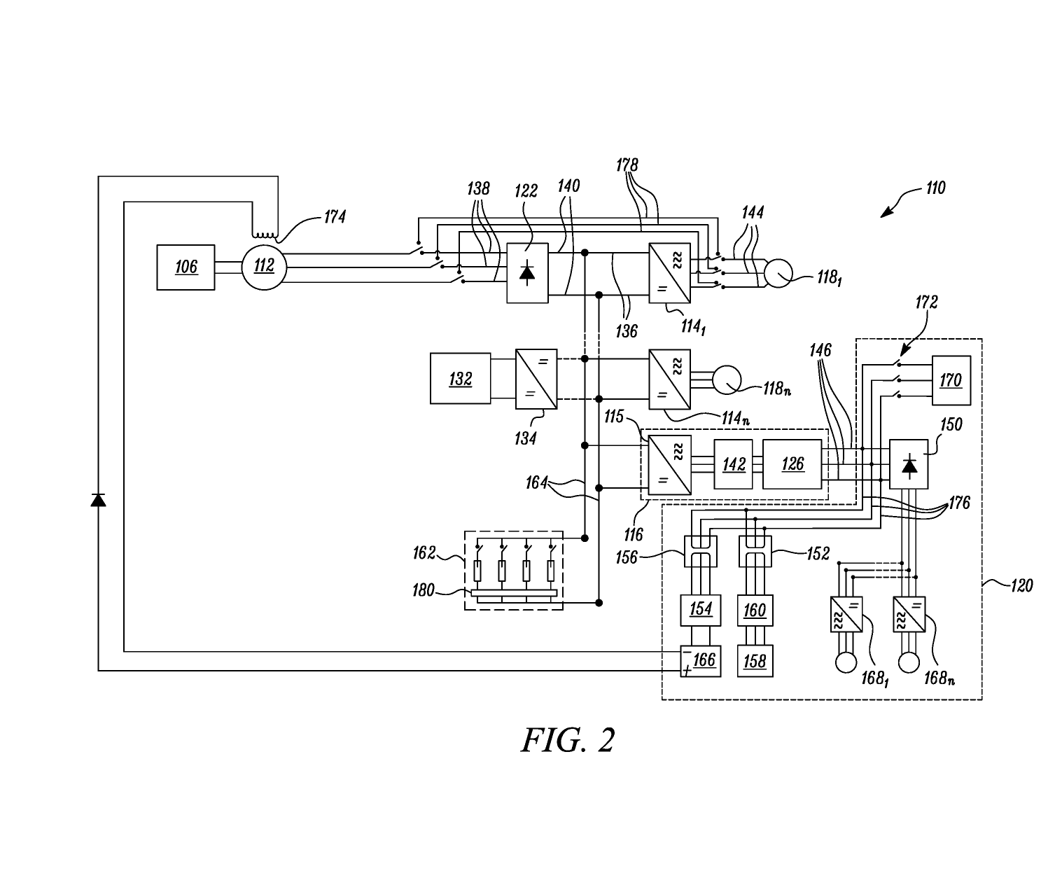

FIGS. 2-6 illustrate elements of an exemplary power system 110 disposed within locomotive 100 for controlling the locomotive 100. The power system 110 is configured to supply power to a plurality of power units. In the embodiment illustrated the power system 110 includes an alternator 112, a first inverter system 114, a second inverter system 116, at least one traction motor 118 and an auxiliary power unit 120.

The alternator 112 is coupled to the engine 106. The engine 106 produces mechanical energy in the form of a mechanical output and transmits it to the alternator 112. The alternator 112 receives this mechanical energy and converts the mechanical energy to electrical energy in the form of alternating current (AC). The alternator 112 may be any device configured to receive mechanical output as input and producing electrical energy as its output. In an embodiment, the alternator 112 may incorporate integral silicon diode rectifiers to provide DC traction, which is used directly. The alternator 112 also has a traction alternator field 174 coupled to it.

In the embodiment illustrated in FIG. 2, the alternator 112 may couple to the first inverter system 114 via a first supply line 136. The alternator 112 may also couple to a first rectifier 122 provided in the power system 110. The alternator 112 may couple to the first rectifier 122 via a second supply line 138. The alternator 112 is configured to transmit high power voltage to the first rectifier 122 and the first inverter system 114. The first rectifier 122 is configured to convert the alternating current (AC) received from the alternator 112 to direct current (DC). This transformed DC is transmitted to a DC link 140. This DC power from DC link 140 is transmitted to the first inverter system 114 and the second inverter system 116 through a DC link 140. In the embodiment illustrated the DC link has high voltage power (max 2800V).

The first inverter system 114 and the second inverter system 116 receive the high voltage power from the DC link 140 and are configured to transform the DC (direct current) from the DC link 140 to AC (alternating current). The first inverter system 114 and the second inverter system 116 supply the transformed AC power to the traction motor 118 and the auxiliary power unit 120 respectively. In the embodiment illustrated, the first inverter system 114 and the second inverter system 116 system may be electronic devices or a series of circuits that transform direct current (DC) to alternating current (AC) and provide the transformed AC to the at least one traction motor 118 and the auxiliary power unit 120.

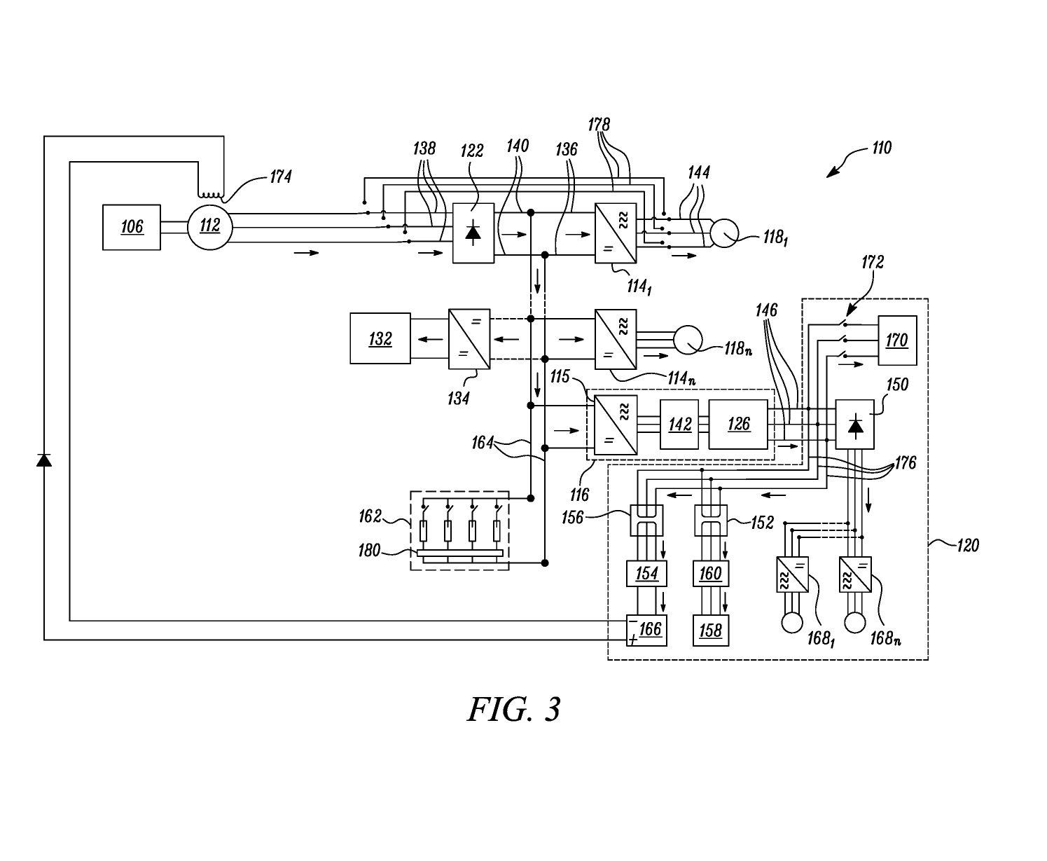

The at least one traction motor 118 is coupled to the first inverter system 114 using a third supply line 144. In the embodiment illustrated, the power system 110 may have at least one first inverter system 114 for converting the DC power to 3-phase AC power and supplying it to the traction motor 118, as shown in FIG. 3. The first inverter system 114 converts DC power in 3-phase variable voltage variable frequency (hereinafter referred as VVVF) AC power and supplies it to the traction motor 118. In an embodiment, the power system 110 may include plurality of first inverters 114a to 114n supplying 3-phase AC power to plurality of traction motors 118a to 118n. The at least one traction motor 118 is configured to provide tractive force to the locomotive 100.

As shown in FIG. 2, the DC link 140 may further be coupled to a storage apparatus 132 via a bi-directional DC converter 134. The storage apparatus 132 is configured to store DC power. In an embodiment, the storage apparatus 132 may include batteries, capacitors, a combination of batteries and capacitors or other energy storage devices known in the art. The bi-directional DC converter 134 allows supply of DC power from the DC link 140 to the storage apparatus 132 and supply of stored DC power from the storage apparatus 132 to the DC link 140. In an embodiment, the storage apparatus 132 is being charged by DC power (regenerated power) produced by the traction motors during the dynamic braking mode of operation. Further, during the dynamic braking mode of operation, the regenerated power generated by the traction motors may be used to power the auxiliary loads via second inverter system 116 connected to the DC link 140. The storage apparatus 132 has a first mode of operation and a second mode of operation. In the first mode of operation the storage apparatus 132 is configured to store energy generated in dynamic braking mode. In the second mode of operation the storage apparatus 132 is configured to power the traction motor 118 via the first inverter system 114 and the auxiliary loads 120 via the second inverter system 116.

As shown in FIG. 3, the auxiliary power unit 120 is coupled to the second inverter system 116 by a fourth supply line 146. In the embodiment illustrated, the second inverter system 116 converts the DC power to low voltage 3-phase AC power and supplies the transformed AC to the auxiliary power unit 120. In an embodiment, the power system 110 may include plurality of second inverter systems 116a to 116n supplying 3-phase AC power to plurality of auxiliary power units 120a to 120n. The auxiliary power unit 120 of the power system 110 is configured to power auxiliary loads on a locomotive 100. The on-locomotive auxiliary loads include the blower for cooling the HV cabinet, radiator cooling fans, blowers, traction alternator excitation, APC, air compressor for the locomotive, a low power 120 Vac outlet system for the cab, and various other loads. In the embodiment illustrated, the high voltage power transmitted to the traction motor 118 is two to four times the value of the low voltage power transmitted to the auxiliary power unit 120.

In the embodiment illustrated in FIG. 2, the second inverter system 116 is coupled to the DC link 140 and receives the high voltage power from the DC link 140. The second inverter system 116 transforms the DC power received from the DC link 140 to AC power. The second inverter system 116 includes an inverter module 115, a filter module 142 and a step-down transformer 126.

The high voltage power is firstly received by the inverter module 115. The inverter module 115 is configured to transform the high voltage DC power received from the DC link to high voltage AC power. This transformed high voltage AC power is then passed to a filter module 142 coupled to the inverter module 115. The filter module 142 receives the AC from the second inverter system 116 and is configured to perform signal processing functions, specifically to remove unwanted frequency components from the AC signals received from the inverter module 115 and enhances the essential frequency components. In the embodiment illustrated, the filter module 142 is configured to remove unwanted harmonics from the AC supplied by the inverter module 115. The filter module 142 may be any of a passive filter, an active filter, an analog filter, a digital filter, a high-pass filter, a low-pass filter, a band-pass filter, a band-stop filter (band-rejection; notch), a discrete-time (sampled) filter, a continuous-time filter, a linear filter, a non-linear filter, an infinite impulse response filter (IIR type), a finite impulse response filter (FIR type) or any other filter known in the art.

The filtered AC from the filter module 142 is transmitted to the step-down transformer 126 present in the second inverter system 116. The step-down transformer 126 is configured to transfer electrical energy through electromagnetic induction and decrease/step down the voltage of alternating current (2800V max to 700V max) to be passed on to the auxiliary power unit 120. In an embodiment illustrated, the step-down transformer 126 is a delta-wye transformer that employs delta-connected windings on its primary and wye/star connected windings on its secondary. A neutral wire may be provided on wye output side. In an embodiment, the delta wye transformer 126 may be a single three-phase transformer, or built from three independent single-phase units. The delta-connected windings on the primary side are configured to eliminate the circulating currents and the imbalances present in the AC received from the filter module 142. The wye-side windings of the step-down transformer 126 are configured to supply a constant output to a variable input from the inverter module 115.

The constant output from the second inverter system 116 is fed to the auxiliary power unit 120. In the embodiment illustrated in FIG. 2-5, the auxiliary power unit 120 includes an auxiliary rectifier 150, a first transformer 152, a second transformer 156, low voltage control system 158, an auxiliary power converter 160, a battery charging apparatus 154, a battery 166, a plurality of three phase auxiliary inverter 168₁ to 168ₙ and contactor driven auxiliary loads 170.

The auxiliary rectifier 150 is configured to transform the stepped down AC power (low voltage) to stepped down DC power. The low voltage DC power is then fed to the plurality of three phase auxiliary inverters 168₁ to 168ₙ. The three phase auxiliary inverters 168₁ to 168ₙ are configured to transform the low voltage DC power into AC power. This transformed low voltage AC power is then fed to the plurality of subsystems of the auxiliary power unit 120 during operation.

The constant output from the second inverter system 116 is also fed to the auxiliary power converter 160 via the sixth supply line 176 and the contactor driven auxiliary loads 170 via the contactors 172. The contactor driven auxiliary loads 170 include auxiliary loads on the locomotive 100 (shown in FIG. 1) which are not always online and thus consume energy only when the contactor 172 is in the closed position.

In the embodiment illustrated, the output of the second inverter system 116 is stepped further down through the first transformer 152 to further step down the low voltage AC power received from the second inverter system 116. The output from the first transformer 152 is fed to the auxiliary power converter 160. The auxiliary power converter 160 is configured to transform the low voltage AC power into constant DC power to supply low voltage control system 158 and locomotive lightings.

The constant output from the second inverter system 116 is fed to a battery charging apparatus 154 through a second transformer 156. The second transformer 156 is configured to step down the low voltage power received from the second inverter system 116. The battery charging apparatus 154 is configured to provide power to charge a battery 166. In the embodiment illustrated, the battery charging apparatus 154 is a device used to put energy into a secondary cell or rechargeable battery by forcing an electric current through it. Further in the embodiment illustrated, the battery charging apparatus 154 works by supplying a constant DC or pulsed DC power source to the battery 166 being charged. The battery 166 is configured to crank the engine 106 using the traction alternator field 174 attached to the alternator 112. The battery supplies power to the traction alternator field 174 which in turn power the alternator 112. The alternator 112 then cranks the engine 106. It may be contemplated that the battery 166 may be a device consisting of two or more electrochemical cells that convert stored chemical energy into electrical energy. In various other embodiments, the battery 166 may be any other type of battery known in the art.

In an embodiment, the power system 110 further comprises a dynamic braking (DB) grid 162. The DB grid 162 is coupled to the DC link 140, first inverter system 114 and the second inverter system 116 via a fifth supply line 164. The DB grid 162 is configured to receive power from the traction motor 118 during dynamic braking mode of operation, of the locomotive 100.

In the embodiment illustrated in FIG. 2-6, a dynamic braking chopper is provided in the DB grids 162. The dynamic braking chopper can added to DB may be configured to extend the locomotive speed range when regenerative energy is captured by the storage apparatus 132. Typically the DB grids 162 have contactors that close in dynamic brake mode, so all the regenerated energy from the traction motor 118 get dumped in to the DB grids 162.

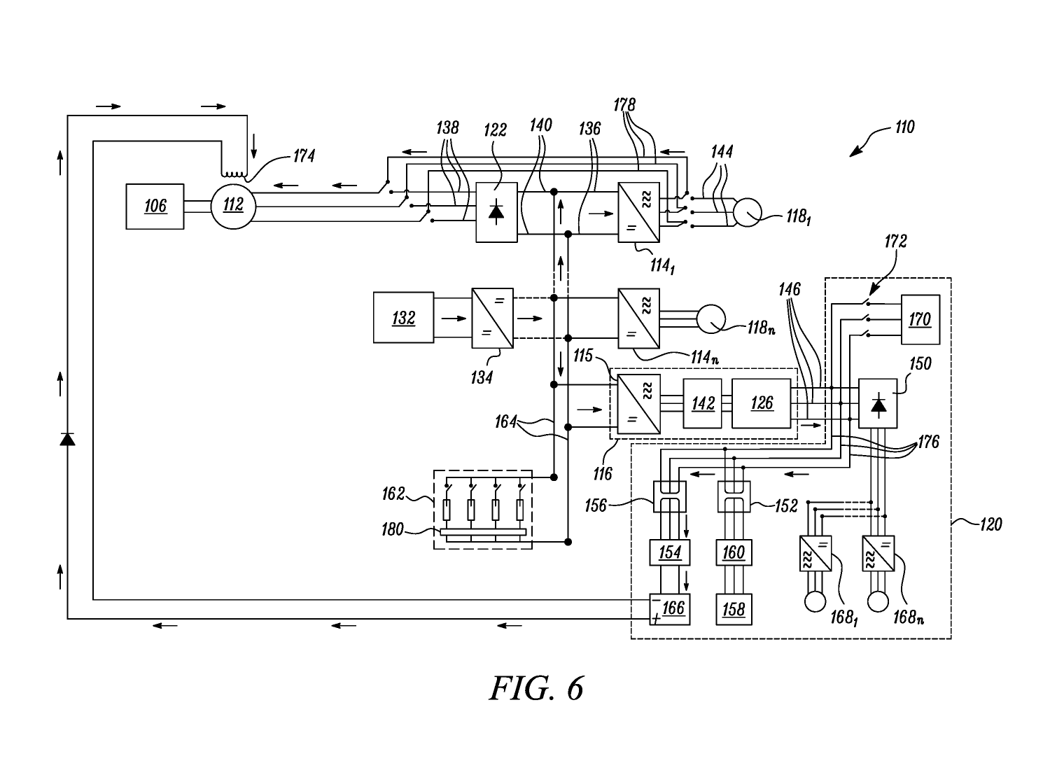

Further, the alternator 122 has an alternator engine cranking mode of operation (AEC mode of operation), as shown in FIG. 6. In the AEC mode of operation the storage apparatus 132 connects to the alternator 112 via the bi-directional DC converter 134. A seventh supply line 178 connects the bi-directional DC converter 134 to the alternator 112. In the AEC mode of operation the alternator 112 acts as a motor to crank the engine 106. In the embodiment illustrated in FIG. 6, the storage apparatus 132 also provides power to the locative battery 166, to support alternator field windings 174.

### INDUSTRIAL APPLICABILITY

In typical locomotives, a locomotive engine powers a traction alternator (also known as main alternator) and a companion alternator (also known as a secondary alternator). The traction alternator produces high voltage power (2800V max) and transmits this high power to the traction motors. The companion alternator produces low voltage power and transmits this low power (700V max) to the auxiliary loads of the locomotive.

In an aspect of the present disclosure, a power system 110 for a locomotive 100 is provided. The power system 110 includes an alternator 112, a first inverter system 114, a second inverter system 116, at least one traction motor 118 and an auxiliary power unit 120. The alternator 112 provides high voltage power to the first inverter system 114 and the second inverter system 116. The first inverter system 114 transmits the high power voltage to the traction motor 118 during operation.

The second inverter system 116 includes an inverter module 115, a filter module 142 and a step-down transformer 126. The alternator 112 provides high voltage power to the inverter module 115. For example, the alternator may transmit high power (max 2800V). This high voltage power received by the inverter module 115 is passed through the filter module 142. The filter module 142 removes the harmonics present in the high voltage power from the alternator 112. Further, it removes unwanted frequency components. The filtered high voltage power is then passed on to the step-down transformer 126. The step-down transformer 126 steps down the high voltage power (2800V max) to a low voltage power (700V max). The stepped down power (low voltage power) is fed to the auxiliary power unit 120. Thus, single alternator 112 provides high power to the traction motors 118. Further, the same alternator 112 provides low power to the auxiliary power unit 120. Thus, in the present disclosure a single alternator 112 powers the high voltage loads as well as the low voltage loads. This results to overall locomotive cost reduction. Further, using a single alternator 112 helps in reducing the hardware required by the locomotive and helps in saving locomotive mechanical rooms space.

In another aspect of the present disclosure, a method 700 for operating a locomotive 100 is disclosed. The method 700 will be explained with reference to FIG. 3. The method 700 includes driving the alternator 112 by the engine 106 (step 702). The alternator 112 produces high voltage power on being driven by the engine 106. The high voltage power generated by the alternator 112 is transmitted to the first inverter system 114 (step 704). The high voltage power received by the first inverter system 114 is transmitted to the traction motor 118 (step 706). The high voltage power generated by the alternator 112 is transmitted to the second inverter system 116 at the same time the high voltage power is transmitted to the first inverter system 114 (step 708). The second inverter system 116 then steps down the high voltage power (2800V max) received by the second inverter system 116 to a low voltage power (step 710). The second inverter system 116 transmits the stepped down power (700V max) by the second inverter system 116 to power the auxiliary power unit 120 (step 712).

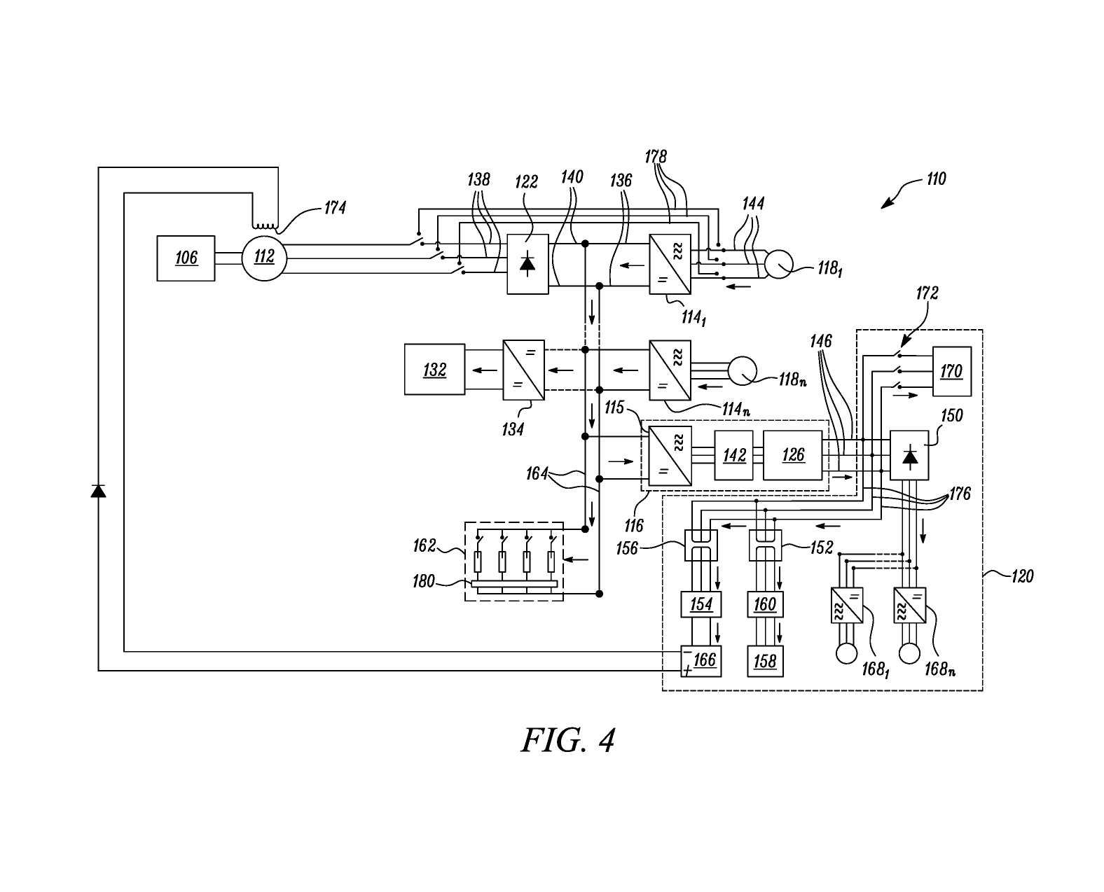

In an aspect of the present disclosure, the power system 110 may be in a regenerative braking mode of operation. In the regenerative braking mode of operation, the traction motor 118 acts as generator and generates 3-phase AC power, as shown in FIG. 4. The first inverter system 114 converts the 3-phase AC power to DC power and supplies it to the DC link 140. The DC link 140 supplies the DC power to all the auxiliary loads via the second inverter system 116 in addition to the DB grids 162. The DC power supplied to the DB grid 162 is at least partly supplied to the second inverter system 116 via the fifth supply line 164 and partly dissipated as heat inside the DB grid 162. The second inverter system 116 supplies power partly to the auxiliary power unit 120 via and partly to the storage apparatus 132 via the bi-directional DC converter 134. The storage apparatus 132 is charged by the DC power supplied by the bi-directional converter 134. The usage of power generated during dynamic braking helps in powering the auxiliary power unit 120. Thus, even when the fuel input to the engine 106 is stopped the auxiliary power unit 120 can run normally. This helps in fuel conservation and helps in achieving more output with lesser amount of fuel being used by the engine 106. In an embodiment, the power stored in the storage apparatus can be utilized during peak power requirements. This helps in reducing fuel input to the engine 106 as the storage apparatus can be used to power the traction motor 118 when more tractive effort is required from the traction motors.

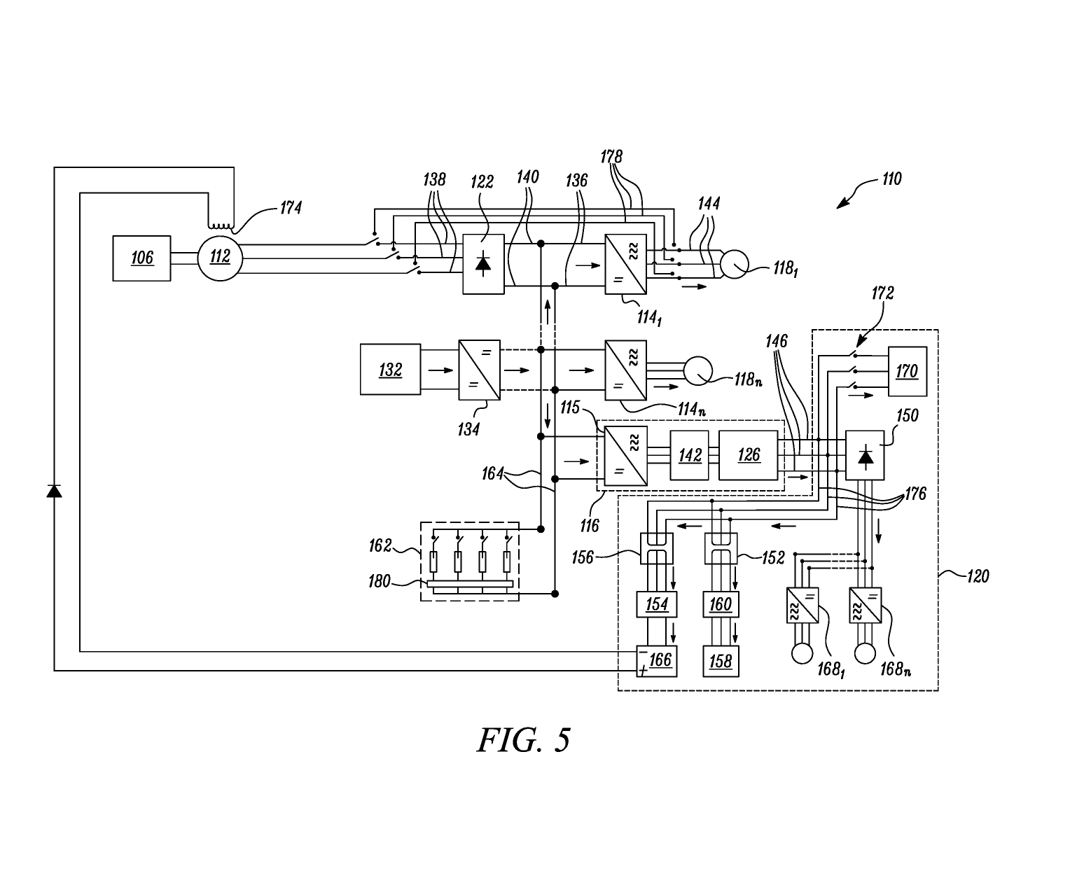

In yet another aspect of the present disclosure, the DC link 140 may be coupled to a storage apparatus 132 via a bi-directional DC converter 134. The storage apparatus 132 is configured to store DC power. The storage apparatus 132 has first mode of operation and second mode of operation. In the first mode of operation the bi-directional DC converter 134 allows supply of DC power from the DC link 140 to the storage apparatus 132 to capture the energy generated during dynamic braking. Thus, in dynamic braking mode of operation at least a portion of the regenerated power flows into the storage apparatus 132 via the bi-directional DC converter 134. In the second mode of operation the storage apparatus 132 supplies DC power from the DC link 140 to the traction motor 118 and the auxiliary power unit 120, as shown in FIG. 5. Thus, the regenerated energy during dynamic braking is stored in the storage apparatus 132 and is utilized to run the traction motors. This promotes fuel efficiency in the locomotive 100 and provides more power output with the same fuel input to the engine 106.

In yet another aspect of the present disclosure, a dynamic braking (DB) chopper 180 is provided in the DB grids 162. The dynamic braking chopper 180 may be configured to extend the locomotive speed range via regenerative energy captured by the storage apparatus 132. Typically the DB grids 162 have contactors that close in dynamic brake mode, so all the regenerated energy from the traction motor 118 get dumped in to the DB grids 162. So when any other loads like auxiliary loads of the auxiliary power units 120 or energy storage (storage apparatus 132 and the bidirectional DC converter 134) run in parallel with the DB grids 162, the voltage on the DC link 140 goes down drastically below certain locomotive speed (for example below 30 MPH) and therefore the regenerated energy from the traction motors 118 can be used only above 30 MPH to power auxiliary loads and charging the storage device in dynamic braking mode. Adding the DB grid chopper 180 to the DB grids 162 extends the locomotive 100 speed range (for example 3 MPH) to capture regenerated energy in dynamic braking mode. That means the auxiliary loads of the auxiliary power units 120 or energy storage (storage apparatus 132 and the bidirectional DC converter 134) can be powered by regenerated energy regenerated energy from traction motors 118 when the locomotive 100 speed is higher than 3 MPH in dynamic braking mode. This results in additional locomotive fuel saving.

While aspects of the present disclosure have seen particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A power system for a locomotive comprising:
an alternator;
a first inverter system coupled to the alternator and configured to receive high voltage power from the alternator;
a traction motor coupled to the first inverter system and configured to receive high voltage power from the first inverter system;
a second inverter system coupled to the alternator, the second inverter system configured to step down the high voltage power from the alternator; and
an auxiliary power unit coupled to the second inverter system, the auxiliary power unit configured to receive the stepped down voltage power from the second inverter system.

2. The power system of claim 1 wherein the second inverter system comprises a delta-wye transformer.

3. The power system of claim 1 wherein the second inverter system comprises a filter module.

4. The power system of claim 1 further comprising a storage apparatus configured to capture regenerated energy in dynamic braking mode.

5. The power system of claim 4 wherein the storage apparatus has a first mode of operation and a second mode of operation, wherein in the first mode of operation the storage apparatus is configured to store regenerated energy in dynamic braking mode and in the second mode of operation the storage apparatus is configured to power the traction motor.

6. The power system of claim 1 further comprising a rectifier configured to convert AC power received from the alternator to DC power.

7. The power system of claim 5 further comprising a bi-directional DC converter configured to allow supply of power from the alternator to the storage apparatus and to allow supply of stored power from the storage apparatus to the first inverter system and the second inverter system.

8. A locomotive comprising:
an engine,
an alternator driven by the engine;
a first inverter system coupled to the alternator and configured to receive high voltage power from the alternator;
a traction motor coupled to the first inverter system and configured to receive high voltage power from the first inverter system;
a second inverter system coupled to the alternator, the second inverter system configured to step down the high voltage power from the alternator; and
an auxiliary power unit coupled to the second inverter system, the auxiliary power unit configured to receive the stepped down voltage power from the second inverter system.

9. The locomotive of claim 8 wherein the second inverter system comprises a delta-wye transformer.

10. The locomotive of claim 8 wherein the second inverter system comprises a filter module.

11. The locomotive of claim 8 further comprising a storage apparatus configured to capture regenerated energy in dynamic braking mode.

12. The locomotive of claim 11 wherein the storage apparatus has a first mode of operation and a second mode of operation, wherein in the first mode of operation the storage apparatus is configured to store regenerated energy in dynamic braking mode and in the second mode of operation the storage apparatus is configured to power the traction motor.

13. The locomotive of claim 11 wherein the alternator has an engine cranking mode of operation wherein the alternator is configured to crank the engine.

14. The locomotive of claim 12 further comprising a bi-directional DC converter configured to allow supply of power from the alternator to the storage apparatus and to allow supply of stored power from the storage apparatus to the first inverter system and the second inverter system.

15. A method of powering a locomotive:
driving an alternator by an engine;
transmitting high voltage power generated by the alternator to a first inverter system;
transmitting the high voltage power received by the first inverter system to a traction motor;
transmitting high voltage power generated by the alternator to a second inverter system;
stepping down the high voltage power received by the second inverter system; and
transmitting the stepped down power by the second inverter system to an auxiliary power unit.

16. The method of claim 15 further comprising converting by a rectifier high voltage AC power generated by the alternator to high voltage DC power.

17. The method of claim 15 further comprising storing regenerated energy generated during dynamic braking mode in a storage apparatus.

18. The method of claim 15 further comprising powering the traction motor by the storage apparatus.

19. The method of claim 15 further comprising powering the traction motor by the storage apparatus during dynamic braking mode.

20. The method of claim 15 further comprising filtering the power received by the second inverter system using a filter module.
